(19) United States
(12) Patent Application Publication
(10) Pub. No.: US 2015/0276795 A1
(43) Pub. Date: Oct. 1, 2015

(54) ATOMIC FORCE MICROSCOPY USING CORRELATED PROBE OSCILLATION AND PROBE-SAMPLE BIAS VOLTAGE

(71) Applicant: CHIPWORKS INCORPORATED, Ottawa (CA)

(72) Inventors: Jessica Maude TOPPLE, Dartmouth (CA); Yoichi MIYAHARA, Montreal (CA); Peter Heinz GRUTTER, Montreal (CA); Zeno Schumacher, Montreal (CA)

(73) Assignee: CHIPWORKS INCORPORATED, Ottawa (CA)

(21) Appl. No.: 14/231,885

(22) Filed: Apr. 1, 2014

(51) Int. Cl. G01Q 10/00; G01Q 60/38

(52) U.S. Cl. CPC G01Q 10/00; G01Q 60/38

(57) ABSTRACT

A method of Atomic Force Microscopy (AFM). A first drive signal is generated for causing a periodic motion of a probe tip in a direction normal to a sample surface. The first drive signal has a known amplitude and frequency. A bias signal is generated for applying an electric potential to the probe tip relative to a potential the sample surface. At least one component of the bias signal is oscillatory and correlated with the periodic motion of the probe tip. A response of the probe tip is detected, and analyzed by a processor to infer information about a composition of the sample surface.

### CROSS-REFERENCE TO RELATED APPLICATIONS

This is the first application filed in respect of the present invention.

### FIELD OF THE INVENTION

The present application relates generally to Atomic Force Microscopy (AFM), and more specifically to AFM techniques using correlated probe oscillation and probe-sample bias voltage to exploit asymmetric electrostatic force-bias curves.

### BACKGROUND

Atomic Force Microscopy (AFM) is well known in the art for imaging nanoscale surface properties. FIG. 1 schematically illustrates principal elements of a conventional AFM microscope. As may be seen in FIG. 1, the AFM microscope probe comprises a cantilever beam 2 having a probe tip 4 at the free end. In dynamic AFM modes, the probe is typically coupled to a piezoelectric element 6 designed to enable the cantilever 2 to oscillate relative to a sample being measured 18. An electronic module 16 receives and processes the electrical detector 10 signals to derive output data indicative of motion of the cantilever beam 2. This data may be processed using known techniques to infer information about the sample surface 22. The electronic module 16 is commonly also configured to generate a set of signals for controlling the position of the sample 18 and the electric potential of the probe tip 4 relative to the sample 18.

In the illustrated system, a sample 18 is mounted on a 3-axis support 20 (such as, for example a piezoelectric tube scanner), which is controlled by a set of 3 orthogonal position signals (Vₓ, V_{y}, V_{z}) from the electronic module 16. Using these position signals, the electronic module 16 can adjust the position of the sample 18 under the probe tip 4, for example to enable the probe tip 4 to interact with the sample surface 22 in a raster-scan pattern. Oscillatory motion of the cantilever 2 relative to the sample surface 22 can be excited, independently of the 3-axis support 20, by means of a cantilever drive signal, V_{d}, which is supplied to the piezoelectric element 6. Finally, a bias signal, V_{b}, may be used to apply a selected voltage difference between the AFM probe and the sample 18. In the example illustrated in FIG. 1, the sample 18 is grounded, so that the voltage difference is established solely by the state of the bias signal, V_{b}. However, other arrangements may equally be used.

Cantilever deflection measurements provide information about the interactions between the probe tip 4 and sample surface 22. These interactions may arise from a variety of forces, such as mechanical, Van der Waals, magnetic, and electrostatic forces. Cantilever deflection measurements may be used for feedback to control the tip-sample separation and to measure and/or control signals related to a variety of surface properties. Deflection of the cantilever beam may be measured in a variety of ways. Some of the most common deflection detection methods include laser 8 beam deflection (illustrated in FIG. 1) and optical interferometry.

AFM imaging is typically performed in either static mode or dynamic mode. In dynamic mode AFM, cantilever 2 is driven to oscillate, usually on or near its fundamental resonance frequency or a higher harmonic. The cantilever oscillation is typically driven by a piezoelectric element 6 (often referred to as a dither piezo), but it may be driven in a variety of other ways, including photothermal excitation. Tip-sample interactions are generally measured by changes in the cantilever dynamics induced during imaging. In static mode AFM, the cantilever 2 is not driven to oscillate, and tip-sample interactions are measured from the static cantilever deflection during imaging.

AFM is most commonly used to image surface topography, but may also be used to image a variety of other surface properties. Several AFM techniques measure surface electronic properties by applying a bias voltage, V_{b}, between the probe tip and the sample. For example, Electrostatic Force Microscopy (EFM) and Kelvin Probe Force Microscopy (KPFM, also known as surface voltage microscopy) involve the application of a bias voltage, V_{b}, and the detection of electrostatic force interactions between the tip and the sample. Both operate by measuring the changes in cantilever dynamics due to the electrostatic force arising from the relative potential difference between the tip and sample surface.

In EFM, a DC bias voltage, V_{b}, is applied across the tip and sample and the resulting cantilever dynamics are measured. Consequently, EFM images pertain to the local electrostatic force between the tip and sample.

In KPFM, an AC bias voltage is applied across the tip and sample and the resulting cantilever dynamics are measured. The component of cantilever oscillation corresponding to the AC bias oscillation frequency, ω/2π, is minimized using a feedback loop to apply a DC bias across the tip and sample corresponding to the local contact potential difference (CPD, approximately equal to the flat band voltage). Consequently, KPFM images pertain to the local CPD between the tip and sample.

In semiconductor analysis, it is frequently desirable to perform dopant profiling to locally map the type (p-type or n-type) and relative concentration of dopant in a sample. There are currently two methods to achieve this by AFM, both of which measure a property related to the local capacitance between the tip and the sample.

The most common technique used for semiconductor dopant profiling is scanning capacitance microscopy (SCM), which is described, for example, by J. R. Matey and J. Blanc, J. Appl. Phys. 47, 1437 (1985). SCM uses a resonant capacitance sensor to detect local differential capacitance, dC/dV. SCM is performed in contact mode (a static mode of AFM in which the probe tip is pressed into the sample surface and a constant cantilever deflection is maintained during imaging), and is particularly susceptible to tip wear. Because the resonant capacitance sensor has a sharp resonance peak, small changes to the tip-sample junction geometry can result in offset changes to the SCM image signal, dC/dV, scale and undesirable image artifacts. Accurate quantitative interpretation of SCM images tends to be difficult, and requires careful calibration and modeling. Therefore, when applied to semiconducting samples, SCM images are generally used to illustrate only the qualitative dopant profile of a sample surface, containing some information about both local mobile charge carrier type (n-type or p-type from the SCM signal phase) and relative concentration (from the SCM signal amplitude).

A second AFM technique for measuring surface properties related to capacitance has been proposed in Y. Martin, D. W. Abraham, and H. K. Wickramasinghe, Appl. Phys. Lett. 52, 1103 (1988)], that may also be applied to semiconductor dopant profiling. Unlike in SCM, this technique measures electrostatic force components and does not require a resonant capacitance sensor. Like in KPFM, an oscillating AC bias is applied across the tip and sample and the resulting cantilever dynamics are measured. In the implementation proposed by Martin et al., the component corresponding to twice the AC bias oscillation frequency, 2ω/2π, is measured. Images acquired by this implementation pertain to the spatial capacitance gradient, dC/dz, but stray capacitance effects result in low sensitivity.

A variation on the electrostatic force technique of Martin et al is described in U.S. Pat. No. 6,823,724 (Kobayashi et al.). In the technique of Kobayashi et al., the component corresponding to three times the AC bias oscillation frequency, 3ω/2π, is measured to reduce the effects of stray capacitance. Images acquired by this implementation, like in SCM, relate to the differential capacitance gradient, dC/dV.

An AFM technique that overcomes at least some limitations of the above-noted prior art would be desirable.

### SUMMARY

An aspect of the present invention provides a method of Atomic Force Microscopy (AFM). A first drive signal is generated for causing a periodic motion of a probe tip relative to a sample surface. The first drive signal has a known amplitude and frequency. A bias signal is generated for applying an electric potential to the probe tip relative to a potential at the sample surface. At least one component of the bias signal is oscillatory and correlated with the periodic motion of the probe tip. A response of the probe tip is detected and analyzed by a processor to infer information about a property of the sample surface.

### BRIEF DESCRIPTION OF THE DRAWINGS

Further features and advantages of the present invention will become apparent from the following detailed description, taken in combination with the appended drawings, in which:

FIG. 1 is a block diagram schematically illustrating an Atomic Force Microscopy device known in the art;

FIGS. 2A and 2B illustrate idealized low-frequency and high-frequency capacitance versus gate voltages of MOS capacitors with p-type and n-type substrates, respectively;

FIG. 3 illustrates asymmetric electric force as a function of bias in accordance with aspects of the present invention;

FIGS. 4A-D illustrate variations in the charge distribution of n-type and p-type semiconductor samples upon interaction with a biased AFM probe tip

FIGS. 5A-E illustrate transient tip-sample electrostatic cantilever excitation changes for a semiconductor sample upon interaction with an oscillating applied bias, V_{AC}, applied in phase with the cantilever oscillation, z_{AC};

FIGS. 6A-E illustrate transient tip-sample electrostatic cantilever excitation changes for a semiconductor sample upon interaction with an oscillating applied bias, V_{AC}, applied 90° out of phase with the cantilever oscillation, z_{AC};

FIG. 7 illustrates the changes in damping, Δγ, and resonance frequency, Δω, of the cantilever as a function of the phase shift, φ, between the cantilever oscillation, z_{Ac}, and correlated oscillating applied bias, V_{AC}, in the bias range of interest;

FIG. 8 is a block diagram illustrating principal elements and operations of an open loop amplitude modulated measuring apparatus in accordance with a first representative embodiment of the present invention;

FIG. 9 is a block diagram illustrating principal elements and operations of a closed loop frequency modulated measuring apparatus in accordance with a second representative embodiment of the present invention;

FIG. 10 is a block diagram illustrating principal elements and operations of a self-excited frequency modulated measuring apparatus in accordance with a third representative embodiment of the present invention;

FIG. 11 is a block diagram illustrating principal elements and operations of a frequency modulated AC bias controlled measuring apparatus in accordance with a fourth representative embodiment of the present invention;

FIG. 12 is a block diagram illustrating principal elements and operations of a self-excited AC bias controlled measuring apparatus in accordance with a fifth representative embodiment of the present invention;

FIG. 13 is a block diagram illustrating principal elements and operations of a measuring apparatus in accordance with a sixth representative embodiment of the present invention; and

FIG. 14 is a block diagram illustrating principal elements and operations of an open loop measuring apparatus in accordance with a seventh representative embodiment of the present invention.

It will be noted that throughout the appended drawings, like features are identified by like reference numerals.

### DETAILED DESCRIPTION

The present technique provides an AFM technique that enables quantitative measurements of surface dopants of a semiconductor sample, by means of correlated probe motion and bias. In the following description, the present technique is described by way of representative embodiments in which the surface dopants of a semiconductor sample are determined from measurements of the electrostatic force interaction between an AFM probe and a semiconductor sample, and do not require an additional capacitance sensor.

The electrostatic force, Fₑₛ, between an AFM probe tip and a sample surface is given by the following formula:

$${F}_{es} = - \frac{1}{2} \frac{d C}{d z} {V}_{e}^{2}$$

where C is the tip-sample capacitance, z is the separation between the tip and the sample, and Vₑ is the effective potential difference across the junction. Vₑ is equal to the difference between the externally applied tip-sample potential, V_{b}, and the contact potential difference, V_{CPD} (which relates to the tip and sample material work functions), Vₑ=V_{b}−V_{CPD}. For simplicity, the effective potential difference, Vₑ, will be referred to herein as the tip-sample bias.

In general, the capacitance of a capacitor is a function of the spacing between electrodes. The capacitance of a metal-oxide-semiconductor (MOS, or equivalently, metal-insulator-semiconductor) capacitor is also a function of applied gate voltage due to band bending. The AFM tip-sample capacitance may then generally be considered a function of both the tip-sample separation, z, and the tip-sample bias, Vₑ; C(z, Vₑ). The electrostatic force between an AFM probe and a sample, using the appropriate tip-sample capacitance gradient, is therefore:

$${F}_{es} = - \frac{1}{2} \frac{d C ( z , {V}_{e} )}{d z} {V}_{e}^{2}$$

It is well known in the art that SCM generally operates based on the principle of a MOS capacitor. The conductive probe tip acts as the metal gate (which needn't actually be metal and is often degenerately doped silicon in MOS devices, but is generally referred to as “the metal” regardless), a surface oxide layer present on the conductor sample surface acts as the insulating oxide (or if no oxide layer is present, the tip-sample junction instead forms a Schottky contact), and the underlying semiconductor sample is contacted to bias the sample.

If the gate bias applied to the “metal” of a MOS capacitor is varied within the accumulation, depletion and/or weak inversion regimes of a device (i.e. near the flatband and threshold voltages), the size of the space-charge region that forms in the semiconductor near the insulator interface will also vary. This variation of depletion-region width is the primary cause of bias-dependent variation of the MOS capacitor capacitance, C(V). (Equivalently, the metal can instead be held at ground and the semiconductor substrate can instead be biased appropriately. For simplicity, we will use the non-essential convention that the substrate be held at ground and gate bias applied to the metal.) This also results in an asymmetric electrostatic force between the tip and sample as a function of tip-sample bias, Vₑ, as will be discussed further below.

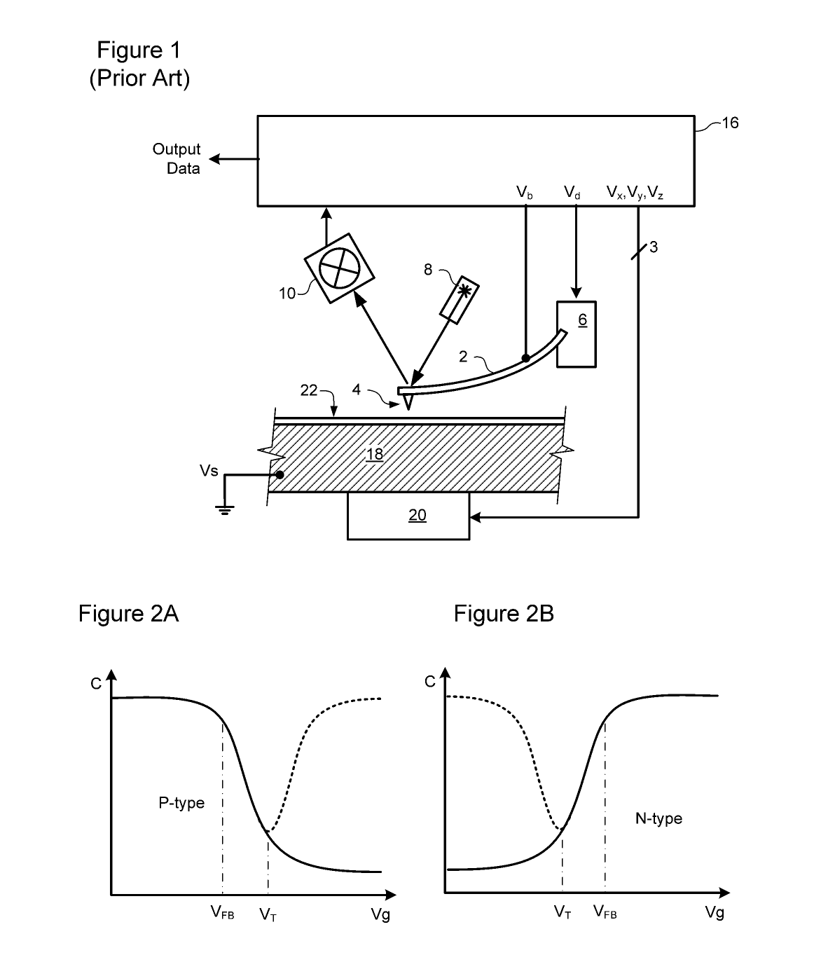

FIG. 2 illustrates idealized low-frequency and high-frequency capacitance versus gate voltages of MOS capacitors with p-type and n-type substrates, respectively. As illustrated, the slope of the bias-dependent capacitance variation in the regime of interest, dC/dV, depends on the type of mobile charge carriers present in the semiconductor. Referring to FIG. 2A, if the semiconductor is p-type, positive charges (holes) accumulate at the semiconductor interface when the gate bias, V_{g}, is below the flat band voltage, V_{FB}. Positive charges recede away from the oxide interface to form a depletion region as the gate bias, V_{g}, is increased between the flatband voltage and the threshold voltage, V_{T}. Negative charges may populate the semiconductor near the oxide interface if the gate bias, V_{g}, exceeds the threshold voltage, V_{T}, and inversion (as indicated by the dashed line in FIG. 2A) is possible.

As the depletion region width increases with applied gate bias up to the threshold voltage (and exceeding it if deep depletion is possible, in the high frequency regime), the gate bias, V_{g}, is dropped across a larger effective electrode spacing and the MOS capacitor capacitance, C, decreases. The capacitance of a p-type MOS capacitor as a function of applied gate bias voltage therefore has a negative slope, dC/dV, for gate bias values below inversion. As may be seen in FIG. 2B, the converse is true for an n-type MOS capacitor, which has an increasing capacitance as a function of applied gate bias, V_{g}, in the region of interest, and therefore a positive slope, dC/dV, above inversion.

It is an important concept to the interpretation of data arising from the present technique that the sign of dC/dV in the gate voltage range of interest (near the flatband and threshold voltages) is indicative of the type of mobile charge carriers present in a doped semiconductor sample. Consequently, the detection of the sign of dC/dV allows for the clear determination of mobile charge carrier type. The magnitude of dC/dV is indicative of the concentration of mobile charge carriers. High charge carrier concentrations allow smaller variations in depletion region width and therefore produce a lower dC/dV than low charge carrier concentrations. This information cannot be directly obtained from AFM techniques measuring surface electronic properties such as EFM and KPFM, and is crucial for semiconductor dopant profiling.

In the high frequency range (typically on the order of 1 MHz), an inversion layer cannot form in the absence of a source of minority charge carriers, and the MOS capacitance includes the deep depletion series component arising from the space-charge region in the semiconductor near the oxide interface. In the low frequency range (typically 5 to 100 Hz), an inversion layer of minority charge carriers forms above or below the threshold voltage for p-type and n-type substrates respectively, and the MOS capacitance returns to the oxide capacitance. Many commercially available AFM cantilevers have resonance frequencies on the order of 100 kHz, between the low and high frequency MOS regimes. In practice, confusion can arise in the low frequency range in the detection of dC/dV if the applied gate bias exceeds the threshold voltage and an inversion layer is allowed to form. It can therefore be desirable to run simultaneous KPFM (discussed further below) to maintain bias oscillations around the flat band voltage, in the monotonic portion of the curve, to minimize the risk of such confusion at low frequencies.

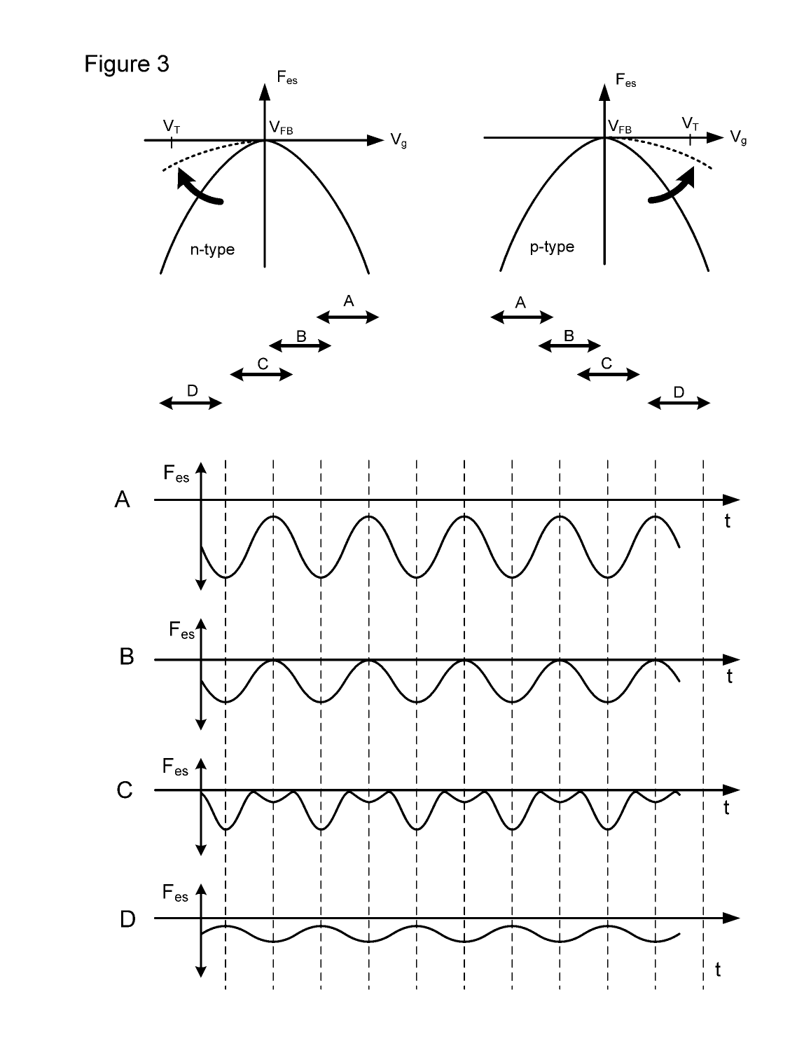

FIG. 3 illustrates the typical parabolic dependence of electrostatic force as a function of applied bias (solid curve) as well as the asymmetric electrostatic force (dashed curve) arising from the voltage-dependent capacitance of a MOS tip-sample junction. Electrostatic force decreases when a given applied bias is dropped across a larger effective electrode spacing, due primarily to the formation of a depletion layer.

As may be seen in, extending the bias dependant change in capacitance (FIG. 2) to the SPM tip-sample junction results in an asymmetric tip-sample electrostatic force, Fₑₛ, as a function of applied bias. If the gate bias, V_{g}, (or equivalently, the effective tip-sample bias, Vₑ) is dropped across a larger effective electrode spacing, for example, due to the formation of a depletion layer, the magnitude of the resulting tip-sample electrostatic force, Fₑₛ will decrease (as indicated by dashed curves), resulting in opposing asymmetric electrostatic force curves for p-type and n-type semiconductors.

FIG. 3 illustrates four different applied bias regimes (denoted by arrows labeled A-D, respectively) and the corresponding attractive electrostatic force, Fₑₛ, generated in each regime. In the case of an n-type semiconductor, Regime B corresponds with a range of gate bias, V_{g}, values extending upward from the flat band voltage, V_{FB}; Regime A corresponds with a range of gate bias, V_{g}, values lying above Regime B; Regime C corresponds with a range of gate bias, V_{g}, values that encompass the flat band voltage, V_{FB}; and Regime D corresponds with a range of gate bias, V_{g}, values that encompass the threshold voltage, V_{T}. In the case of a p-type semiconductor, the four Regimes mirror those of the n-type semiconductor.

If a sinusoidal oscillating bias is applied across a MOS SPM tip-sample junction within Regime A, the resulting attractive electrostatic force, Fₑₛ, between the tip and sample will oscillate as a function of time as illustrated in chart A. If the applied bias range intersects with the flatband voltage, V_{FB} (approximately equal to the contact potential difference), as in Regimes B and C, the electrostatic force, Fₑₛ, will reach zero at these points

If the applied bias range extends into the portion of the electrostatic force that is decreased due to the MOS like behaviour of the tip-sample junction, as in Regimes C and D, less modulation of electrostatic force arises as a function of applied bias than would occur for the same geometry of a capacitor with two metal electrodes. If an oscillating applied bias represented by Regime C were applied across the same geometry of a capacitor with two metal electrodes, the resulting electrostatic force, Fₑₛ, as a function of time would oscillate sinusoidally with twice the applied AC bias frequency. The present technique takes advantage of the asymmetry in electrostatic force arising from the MOS behavior of the tip-sample junction. This technique is therefore suited for operating in any of Regimes A-C. The methodology is clarified in further discussion below.

In order to take advantage of the asymmetric electrostatic force as a function of applied bias of a MOS tip-sample junction, the bias applied across the junction, V_{b}, should be phase and frequency locked to the AFM cantilever oscillatory motion, z. In other words, V_{b} and z should be both coherent and correlated. This allows p-type and n-type sample regions to be differentiated. As the tip-sample separation position, z, changes, the correlated tip-sample bias, V_{b}, also changes.

The tip-sample separation during oscillation can be described as:

z=z₀+z_{AC}

where z₀ is the steady state tip-sample separation and z_{AC} is the oscillating component, given by:

z_{AC}=A_{c}e^{i(ωt)}

or

z_{AC}=A_{c} sin(ωt)

Subsequently, A_{c} is the peak cantilever oscillation amplitude, and ω/2π is the oscillation frequency. We apply a tip-sample bias voltage:

V_{b}=V_{DC}+V_{AC}

where V_{DC} is the DC component of the bias (including any correction for V_{CPD} to the externally applied DC bias) and V_{AC} is the oscillating component, given by:

V_{AC}=A_{V}e^{i(ωt+φ)}

or

V_{AC}=A_{V} sin(ωt+φ)

where A_{V} is the peak bias oscillation amplitude, and the oscillation occurs at the same frequency ω2π, with a phase shift of φ relative to z_{AC}.

Aspects of the resulting AFM cantilever dynamics (such as oscillation amplitude, phase and frequency) can be measured and related to the probe-sample electrostatic force behaviour. Various embodiments of the present technique comprise determining an electrical property of the sample. In the case of a doped semiconducting sample, this electrical property pertains to the majority mobile charge carrier type and dopant concentration. However, the present technique is not limited to doped semiconducting samples. Depending on the nature of the sample under test, the electrical property analyzed by the present technique may pertain to any one or more of the contact potential difference, work function, polarizability, or relative permittivity of a sample.

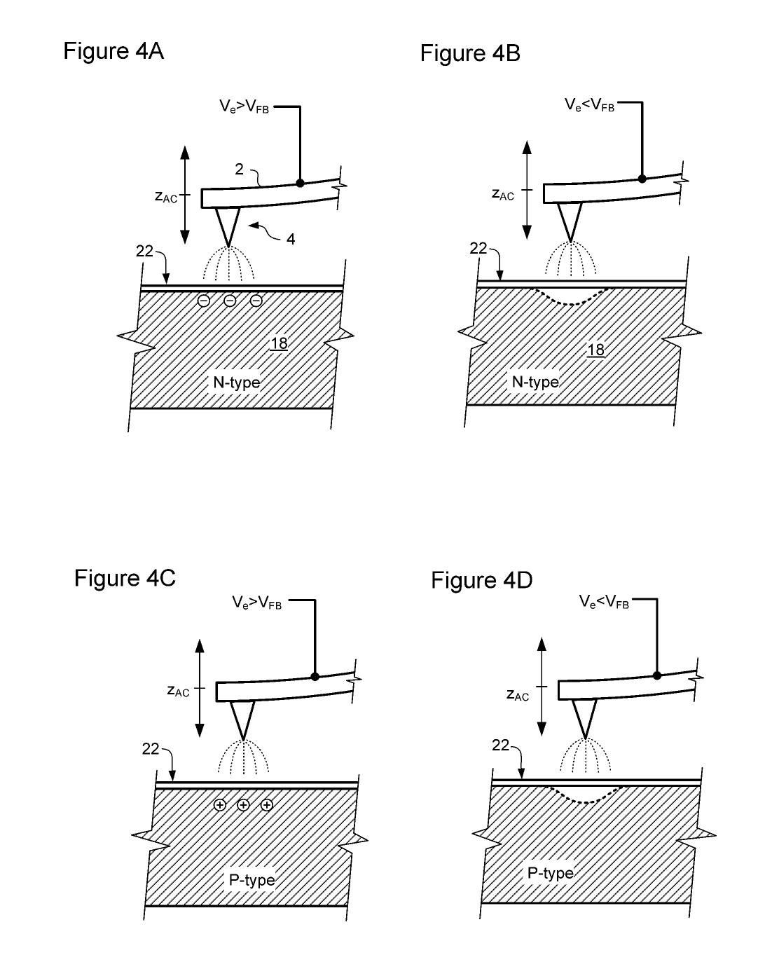

FIGS. 4A and B illustrate instantaneous electrostatic force interaction cases for a semiconducting substrate with negative charge mobile carriers (n-type), assuming operation in voltage Regime C. FIGS. 4C and 4D mirror the example of FIGS. 4A and 4B for the case of a p-type semiconductor. Accumulation and depletion cases are illustrated, as discussed above with reference to FIG. 2.

As may be seen in FIG. 4, if the effective gate bias applied across an n-type semiconductor increases within the regime of interest (between accumulation and deep depletion), the attractive tip-sample electrostatic force increases: negative charge carriers move toward the semiconductor-oxide interface (decreasing the width of any depletion layer present) and may accumulate at the semiconductor surface. Conversely for a p-type semiconductor, if the effective applied gate bias increases within the regime of interest, the tip-sample electrostatic force decreases: positive charge carriers recede from the semiconductor-oxide surface to increase the width of any depletion layer present, resulting in a larger effective electrode spacing.

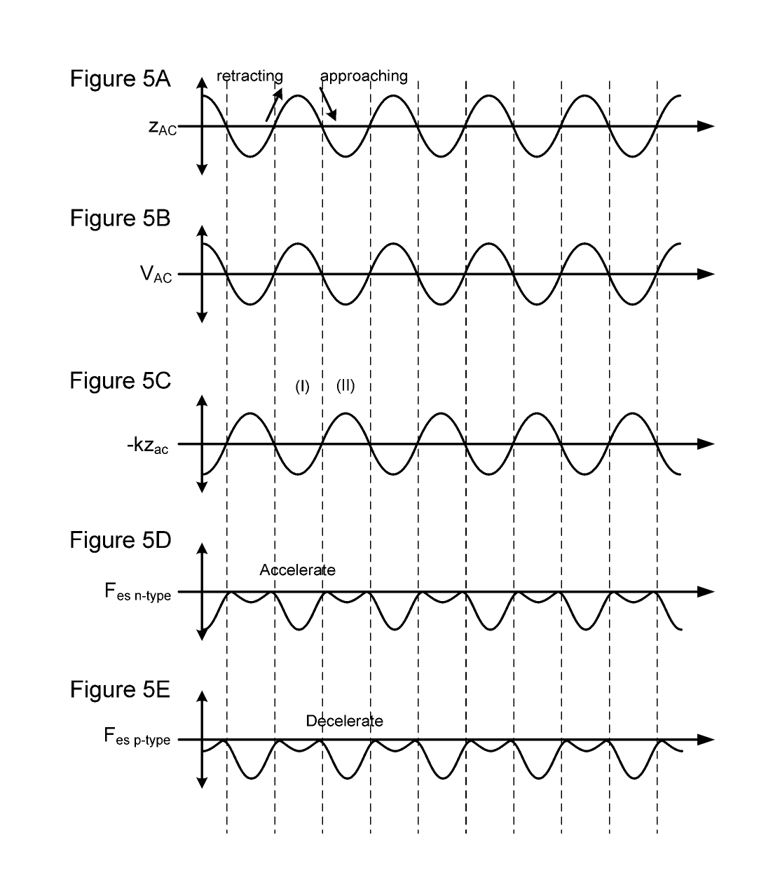

FIGS. 5A-5E illustrate an oscillating bias component, V_{AC}, in Regime C (as shown in FIG. 3) applied to the tip relative to the sample that is in phase with the cantilever oscillation, z_{AC} (FIGS. 5. A and B respectively). The resulting tip-sample electrostatic force alternates between increasing and decreasing within each oscillation period for both n-type and p-type samples (FIGS. 5 D and E respectively). In the regions labelled (I) and (II), the electrostatic force between the probe tip and an n-type sample increases (decreases) as the tip retracts away from (approaches) the sample surface. This varying force effectively enhances (reduces) the restoring force of the cantilever (FIG. 5C) in the region (I) (in the region (II)), leading to a net positive shift of the cantilever resonance frequency. Conversely, a negative cantilever resonance frequency shift results for a p-type sample. A change in cantilever dynamics as a result of the resonance frequency shift can be detected from the change in the oscillation amplitude or phase in open loop implementations, or from the oscillation frequency in closed loop implementations, as discussed in detail below. Consequently, the measured cantilever dynamics can be related to variations taking place in the charge distribution of a semiconducting sample upon interaction with the oscillating AFM probe. The opposite polarity response (positive or negative) of the resonance frequency shift to the different doping types (n-type or p-type) is the fundamental principle of the proposed method.

If a phase shift of π is used instead of zero between z_{Ac} and V_{AC}, the correspondence between the doping type and the sign of the frequency shift simply exchanges (negative frequency shift arises for an n-type semiconducting sample and a positive frequency shift arises for a p-type sample). In both cases (phase shift of 0 and π), the work done by the electrostatic force in each region (I) and (II) is opposite in sign and equal in magnitude, resulting in zero net work (conservative interaction).

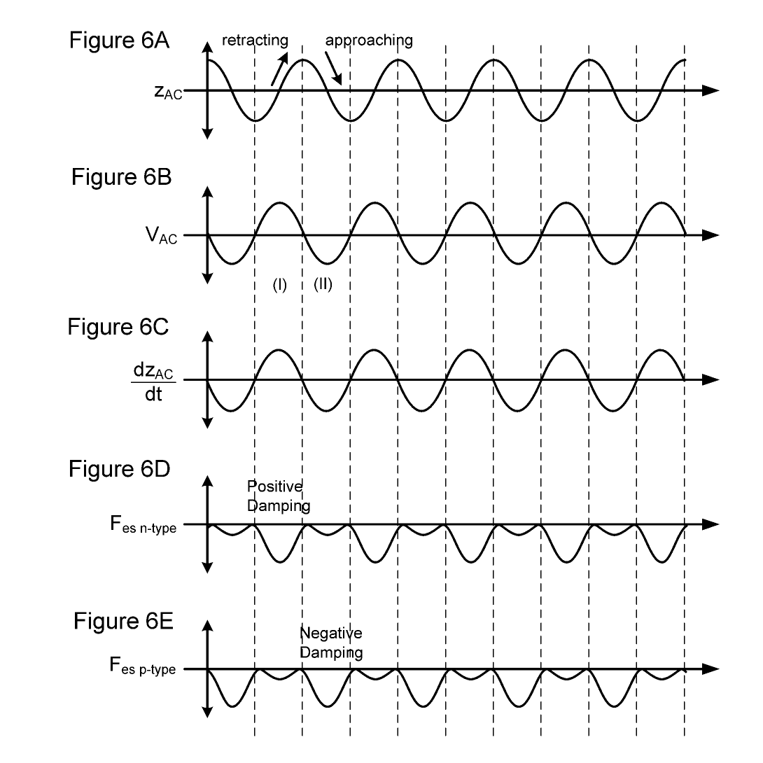

If the oscillating bias, V_{AC}, is applied π/2 out of phase with the cantilever oscillation, z_{AC}, as illustrated in FIGS. 6A and 6B, the resulting tip-sample electrostatic force varies in phase with the tip velocity. The electrostatic force therefore acts as an effective viscous damping (which is proportional to the tip velocity, dz/dt, shown in FIG. 6C). While in region (I) for an n-type sample, the electrostatic force does negative work on the cantilever, resulting in positive damping. In region (II), the electrostatic force does positive work on the cantilever, resulting in negative damping (excitation). Over one complete oscillation cycle, a net positive damping is expected due to the asymmetric electrostatic force for n-type samples. Conversely, negative damping is expected for p-type samples, again due to the asymmetric electrostatic force. As no change in the resonance frequency shift arises from the oscillating electrostatic force in this case, the frequency shift can be conveniently used for distance regulation as in the normal frequency modulation mode AFM.

If the phase difference between the applied AC bias, V_{AC}, and cantilever oscillation, z_{AC}, is 3π/2 instead of π/2, the electrostatic force responses will be the opposite of those illustrated in FIG. 6 for both n-type and p-type samples. Thus for a phase shift of 3π/2, an n-type (p-type) sample will elicit negative (positive) damping of cantilever oscillations. Both cases (phase shift of π/2 and 3π/2) may be considered as dissipative interactions and effectively change the quality factor of the cantilever.

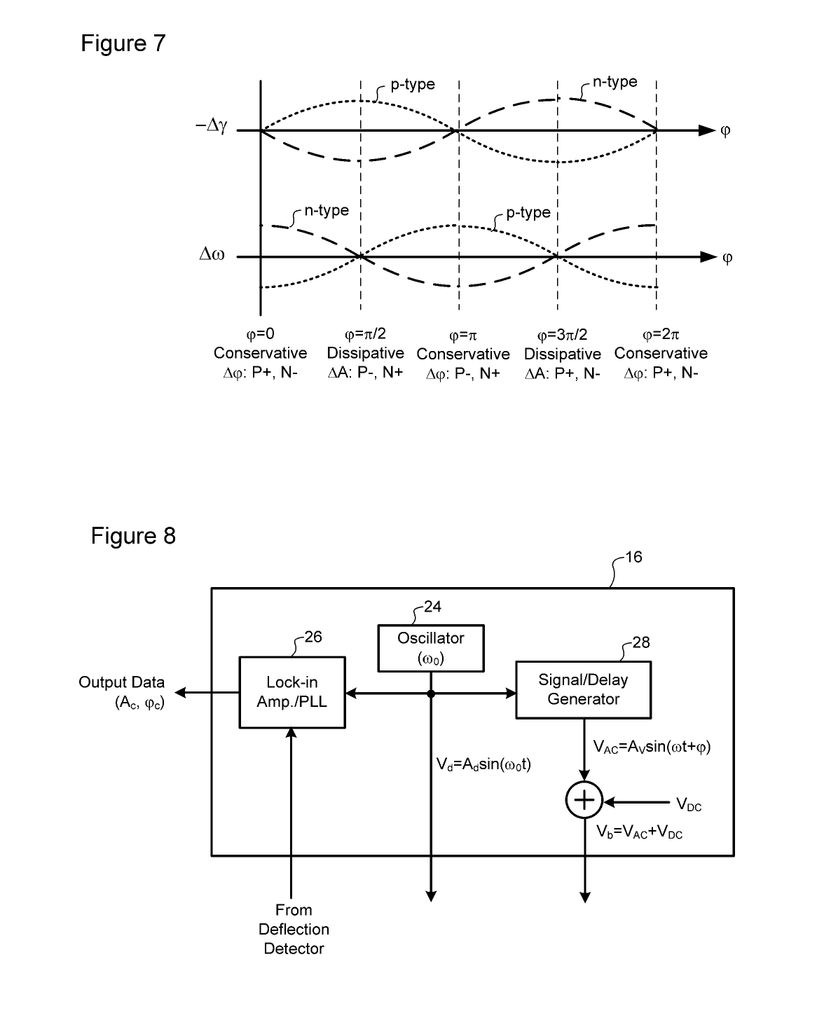

FIG. 7 illustrates the changes in cantilever damping and resonance frequency that arise from asymmetric electrostatic force interaction as a function of phase difference, φ, between the applied AC bias, V_{AC}, and cantilever oscillation z_{AC}. These may produce measurable changes in open loop cantilever oscillation amplitude, ΔA_{C}, or closed loop dissipation (equal to the change in drive amplitude) Δy, and open loop phase, Δφ_{C}, or closed loop frequency shift, Δω/2π,

When the phase difference, φ, is 0 or π (or, more generally, an even multiple of π/2), the electrostatic interaction is conservative (as discussed above with reference to FIG. 5) and the resulting tip-sample electrostatic force interactions alternate (ideally equally) between damping and exciting the cantilever for both charge carrier types within each oscillation period. These interactions cancel within each oscillation period, resulting in no net change in the cantilever damping. However, the effective increase or decrease in the restoring force of the cantilever will produce a shift in the cantilever resonant frequency, Δω/2π, as illustrated in FIG. 7. This allows for the detection and differentiation of p-type and n-type mobile charge carriers using (open loop) amplitude and phase or (closed loop) frequency detection techniques.

When the phase difference, φ, is π/2 or 3π/2 (or more generally, an odd multiple of π/2), the electrostatic interaction is dissipative (as discussed above with reference to FIG. 6). Positive or negative damping will change the energy dissipated as the cantilever oscillates, γ. It will therefore change the (open loop) cantilever oscillation amplitude, A_{C}, or the (closed loop) drive signal amplitude required to maintain constant amplitude cantilever oscillations, A_{d}. This allows for the detection and differentiation of p-type and n-type mobile charge carriers using (open loop) amplitude, or (closed loop) dissipation detection techniques.

As may be appreciated from FIG. 7, depending on the phase shift between the correlated cantilever oscillation, z_{Ac}, and the applied AC bias, V_{AC}, the mobile charge carrier induced modulation of probe-sample electrostatic force will produce either a change in the cantilever resonance frequency (conservative interaction), damping (dissipative interaction), or a combination of the two. However, in all cases, positive and negative mobile charge carriers induce changes to the cantilever dynamics that are of opposite phase for any applied phase difference between cantilever oscillation and applied bias. This important concept allows for clear differentiation between positive and negative mobile charge carrier types from analysis of the detected cantilever dynamics.

Several representative embodiments for implementing the present technique on an AFM system are described below. These embodiments include either open loop or closed loop control of the cantilever oscillation dynamics. The oscillating bias signals may be generated by either fixed or variable oscillators. Both open loop and closed loop embodiments of the present technique are possible. Open loop embodiments involve measuring the cantilever dynamic response to electrostatic force interactions with the sample surface while the cantilever oscillation is excited at a fixed drive frequency. Conversely, closed loop versions involve maintaining a constant cantilever oscillation amplitude, A_{c}, (or phase, φ_{c}) by varying either the cantilever drive signal, V_{d}, or the applied tip-sample bias voltage, V_{b} while the resonant frequency shift is tracked by a feedback loop. Additionally, various forms of KPFM can be performed during imaging to provide advantageous DC biases across the tip and sample. Alternative embodiments will also be discussed.

FIG. 8 is a block diagram of a dynamic mode electronics module usable in an AFM system in accordance with the present invention. In the embodiment of FIG. 8, an oscillator 24 is used to provide a cyclic drive signal, V_{d}, to the dither piezoelectric element, so as to cause an oscillatory motion of the probe tip 4 relative to the sample surface. The cyclic drive signal, V_{d}, may have any suitable waveform. In the illustrated embodiments, the cyclic drive signal, V_{d}, is sinusoidal, but this is not essential. The oscillator 24 also provides a reference signal to a lock-in amplifier or phase locked loop (PLL) 26 used to detect components (amplitude and/or phase) of the deflection detector signal corresponding to the oscillator drive frequency. These detected components represent the beam deflection data from which tip/sample interactions can be determined and properties of the sample inferred.

The fixed frequency oscillator signal is also supplied as a trigger for a signal/delay generator 28 used to generate an oscillating constant amplitude AC bias signal, V_{Ac}. This AC bias signal, V_{AC}, may optionally be added to a DC offset bias V_{DC}, which may be selected to tune the measurement response. The resulting bias signal, V_{b}=V_{AC} V_{DC}, is then supplied to the cantilever 2 to bias the probe tip 4. The measured amplitude and phase of the cantilever oscillation at each pixel of an AFM image can be used to extract dissipative and conservative probe-sample interactions at the corresponding location of the sample surface 22. The ratio between the amplitude and phase responses depends on the phase of the applied tip-sample bias signal, as described above with reference to FIG. 7.

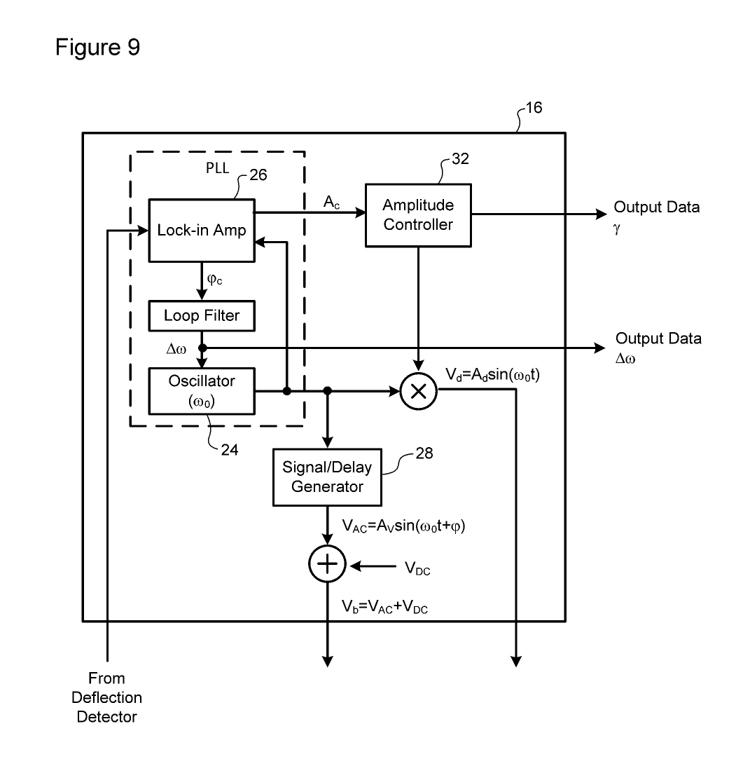

Alternatively, a PLL 26 with a variable frequency oscillator 24 can be used in conjunction with an amplitude controller feedback loop to produce the cantilever drive signal and measure changes in closed loop components (dissipation and/or frequency shift) of the deflection detector signal. FIG. 9 is a block diagram of a dynamic mode AFM electronics module 16, similar to the embodiment of FIG. 8, except that this method is a frequency modulation configuration of the present technique. In this case, a PLL variable frequency oscillator 24 is used to generate both the signal/delay generator trigger signal and the cantilever drive signal, V_{d}, matched to the phase (and frequency) of the output of the cantilever deflection detector 10. An amplitude controller 32 is used to adjust the amplitude of the cantilever drive signal, A_{d}, to maintain a constant cantilever oscillation amplitude, A_{c}, in this closed loop implementation. Constant cantilever oscillation amplitude embodiments in general can yield higher resolution measurement results than open loop embodiments by limiting the cantilever oscillation dynamic range. The measured cantilever resonant frequency shift, Δω/2π, and change in dissipation, Δγ (or drive signal amplitude, A_{d}), at each pixel of an AFM image correspond to conservative and dissipative probe-sample interactions respectively at the corresponding location of the sample surface 22.

It should be noted that if the tip-sample applied bias, V_{b}, range is large enough that the cantilever 2 is driven in excess of the amplitude controller setpoint by electrostatic excitation, even a zero drive signal, V_{d}, may not reduce the cantilever oscillations to within the setpoint. In this case, a negative drive amplitude (corresponding to a π out of phase drive, related to active Q control) may be applied to compensate the cantilever oscillations and should be considered in data interpretation.

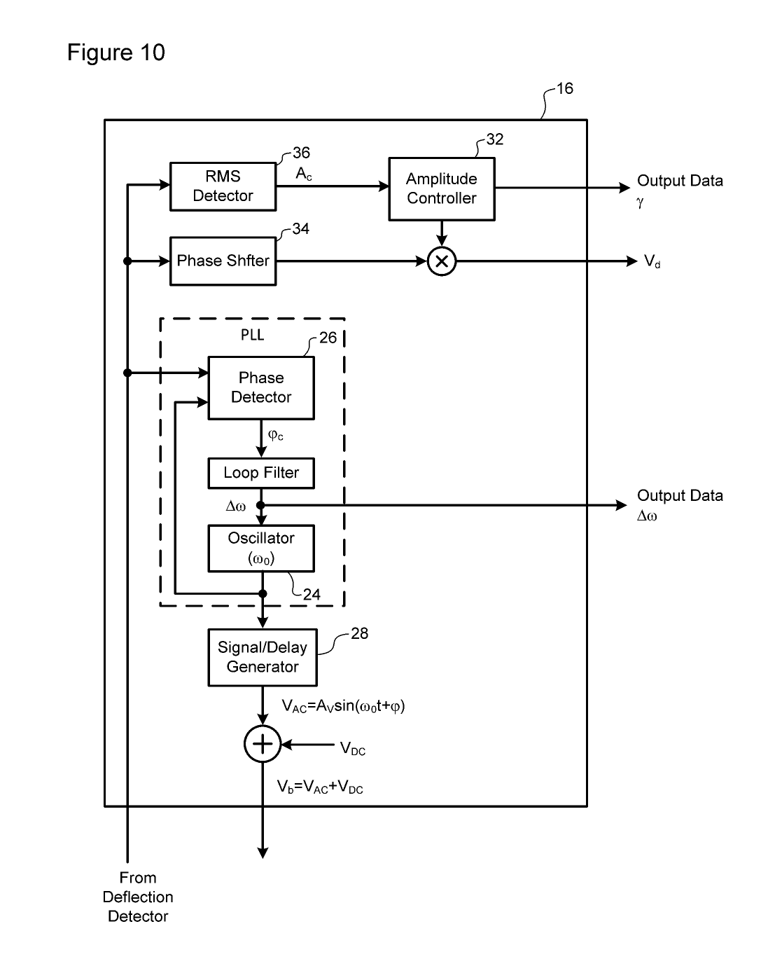

FIG. 10 is a block diagram of a dynamic mode AFM electronics module 16 similar to the embodiment described in FIG. 9, except that in the embodiment of FIG. 10, the oscillating deflection detection signal is used to provide self-excitation for the cantilever drive, V_{d}, through the use of a feedback loop. The deflection signal phase is shifted by a desired phase offset using a phase shifter 34, and an amplitude controller 32 is used to produce a constant amplitude oscillating drive signal. The use of a self-excitation scheme has an advantage over an oscillator in terms of generating a signal that is inherently phase (and frequency) matched to the input signal rather than relying on a PLL feedback system to generate such a signal. In this closed loop embodiment, a simple RMS detector 36 is used to measure the amplitude of the cantilever deflection detector signal instead of a lock-in amplifier, and only a PLL frequency detector feedback loop is needed to produce the AC bias trigger signal V_{AC} and measure the cantilever resonant frequency shift.

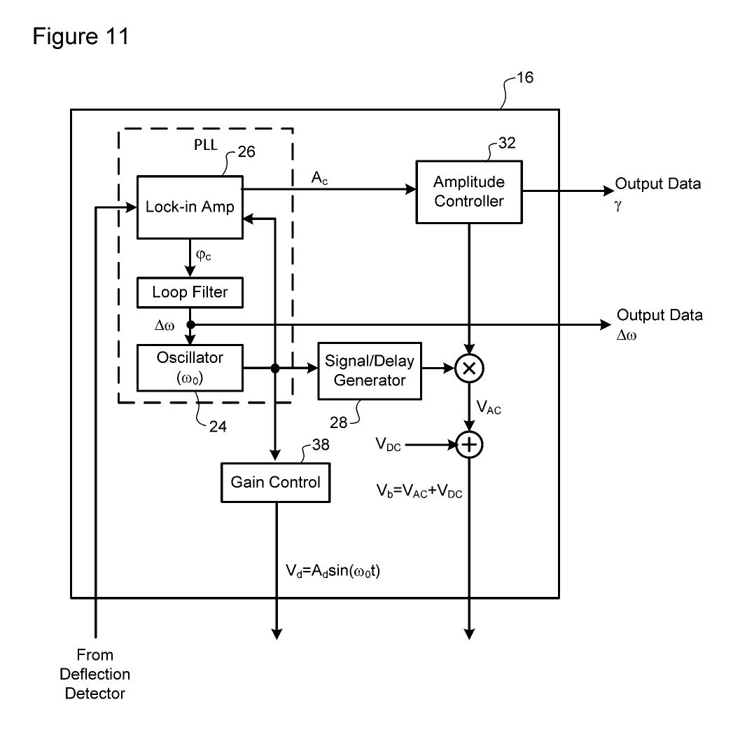

FIG. 11 is a block diagram of a dynamic mode AFM electronics module 16 similar to the embodiment described in FIG. 9, except that instead of maintaining a constant cantilever oscillation amplitude by controlling the cantilever drive, V_{d}, the embodiment of FIG. 11 does so by controlling the AC component of the applied bias, V_{AC}. In this “closed loop” embodiment, the amplitude of the cantilever drive signal, A_{d}, remains constant and is set by a gain controller 38. As in FIG. 9, the variable frequency oscillator 24 of the PLL generates both the AC bias trigger signal and the cantilever drive signal. However, an amplitude controller 32 feedback loop is used to vary the AC bias amplitude in order to maintain a constant cantilever oscillation amplitude.

This embodiment is akin to conventional closed loop SCM techniques, and may yield high resolution measurements by maintaining an approximately constant sample probe volume. The amplitude of the AC applied bias at each pixel of an AFM image relates to the concentration of mobile charge carriers at the corresponding location of the sample surface 22. It should be noted that if the cantilever drive signal range is large enough such that the cantilever is driven in excess of the amplitude controller setpoint, even zero applied bias signal will not reduce the cantilever oscillations to within the setpoint. In this case, a negative applied bias signal amplitude (corresponding to a 180 degrees out of phase applied bias, again related to active Q control) may be applied to compensate the cantilever oscillations and must be considered in data interpretation.

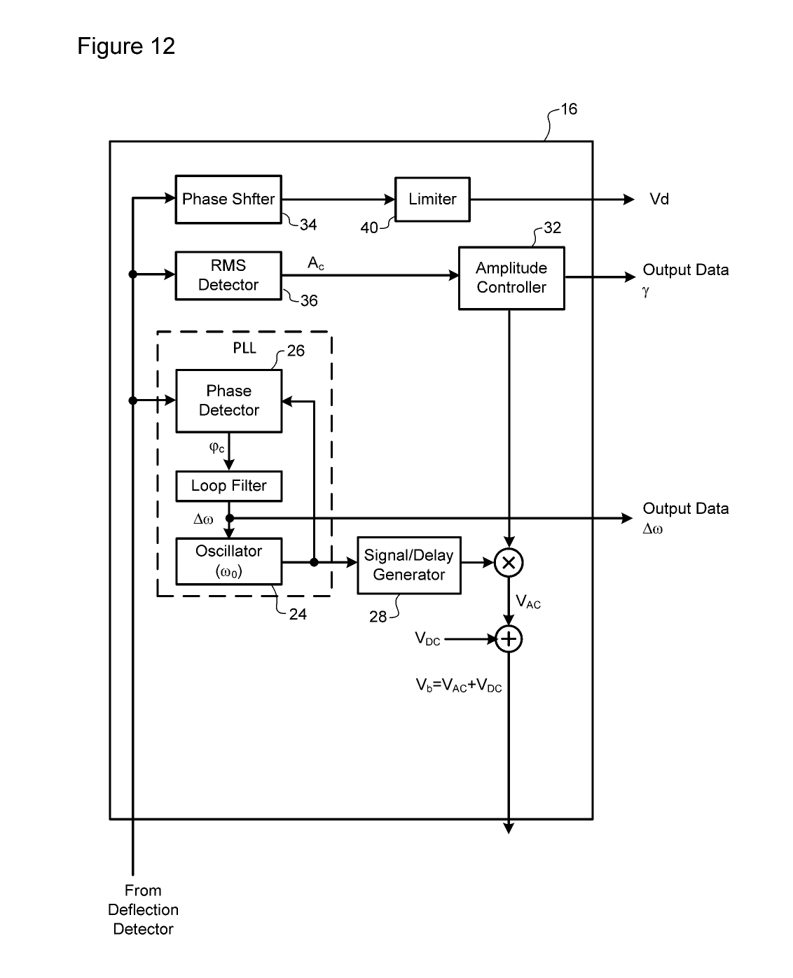

In the embodiment of FIG. 11, the cantilever drive signal, V_{d}, and applied AC probe bias, V_{b}, are generated using the PLL, in the same manner as described above with reference to FIG. 9. However, it will be appreciated that alternative arrangements may be used, such as the self excitation scheme illustrated in FIG. 10. FIG. 12 is a block diagram of a dynamic mode AFM electronics module 16 that implements closed-loop amplitude control of the applied tip-sample bias signal, V_{b}, similar to the embodiment shown in FIG. 11. As in FIG. 11, the tip-sample bias signal amplitude is varied by a controller 32 to produce a constant cantilever oscillation amplitude, but the constant amplitude cantilever drive signal, V_{d}, is generated by a self excitation scheme as in FIG. 10, with amplitude set by a limiter 40 instead of amplitude control feedback. The oscillating deflection detection signal is used to provide the self-excitation signal for the applied AC probe bias. The deflection signal phase is shifted by the desired phase offset, and a gain controller is used to produce a constant amplitude oscillating signal. The AC component of the tip-sample applied bias signal, V_{AC}, is then added to an optional user defined DC offset bias and applied to the AFM probe. The applied AC tip-sample bias amplitude at each pixel again relates to the concentration of mobile charge carriers within the sample.

Measurements pertaining to the technique can be performed in conjunction with CPD compensation by Kelvin Probe Force Microscopy (KPFM). This may improve operation by centering the applied bias in the regime of interest and allow quantitative characterization of semiconductor dopant concentration, and also allows measurement of the CPD minimum. The tip-sample CPD is not always negligible, but is generally ignored (or assumed constant across a sample) while performing SCM (despite the fact that this can lead to discrepancies in the relative amplitudes of p-type and n-type area SCM signals). Methods in accordance with the present technique can produce useful results when performed without CPD compensation. However, improved performance is possible with CPD compensation, which is therefore desirable.

It should be noted that while the electrostatic force is no longer parabolic about the CPD minimum due to the voltage dependent tip-sample capacitance gradient (arising from the MOS capacitance model), the steady-state electrostatic force will still be minimized near the flat band condition, approximately equal to the CPD minimum, where the effective tip-sample applied bias is zero.

$${F}_{es} = - \frac{1}{2} \frac{d C ( z , V )}{d z} {V}_{e}^{2} .$$

Those skilled in the relevant art will recognise that several different KPFM configurations may be used in conjunction with the present technique. In principle, a variety of modulation frequencies are suitable for KPFM, but must be selected appropriately for the apparatus by considering measurement detection bandwidth. As is known in the art, frequency modulated (FM) KPFM is advantageous because it enables improved spatial resolution compared to amplitude modulated (AM) KPFM because the force gradient (relating to the cantilever oscillation frequency shift) decays faster than the force (relating to the cantilever oscillation amplitude). In double pass embodiments, KPFM may be performed during either the forward topography scan or the lifted backscan. While an extensive list will not be presented herein, two representative embodiments are described below, it being understood that alternate KPFM configurations may be used without departing from the intended scope of that attached claims.

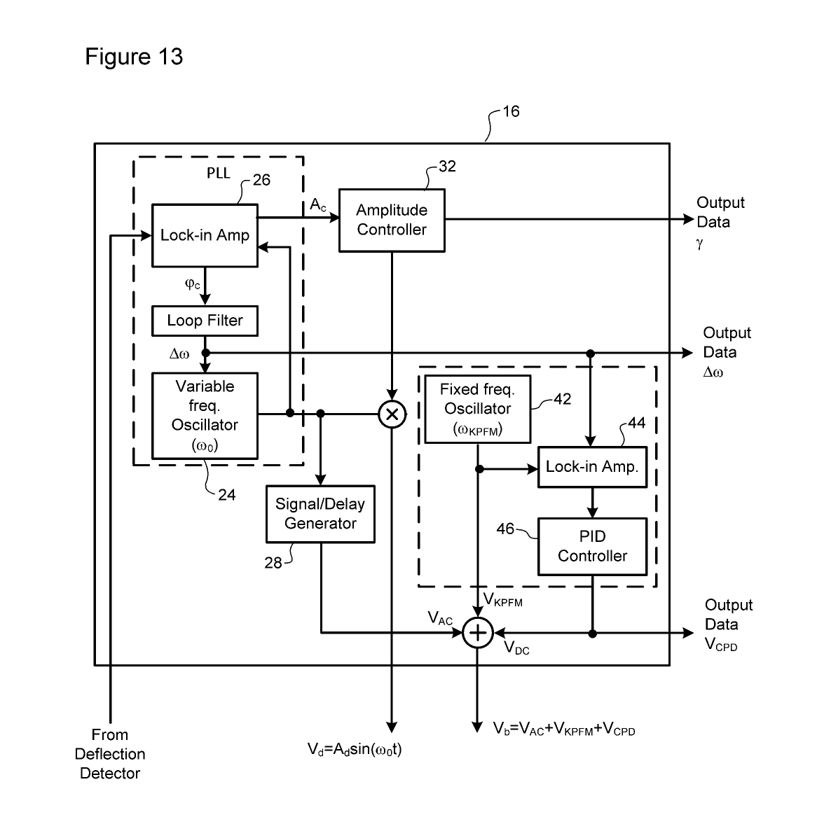

FIG. 13 is a block diagram of a dynamic mode AFM electronics module 16 similar to that shown in FIG. 9 with an added frequency modulated KPFM feedback loop to set the DC applied bias to compensate CPD.

In the embodiment of FIG. 13, a fixed frequency oscillator 42 is used to generate a KPFM component, V_{KPFM}, which oscillates at the predetermined KPFM oscillation frequency (which may be user-selected). The KPFM component, V_{KPFM}, is added to the AC and DC bias components, V_{AC} and V_{DC}, to produce the applied tip-sample bias signal, V_{b}. It also serves as the reference signal for a lock-in amplifier/PLL 44 in the Kelvin loop. The cantilever resonant frequency shift signal is supplied as the input to this lock-in 44, and a controller 46 is used to minimize the frequency shift modulation at the KPFM frequency by applying a constant DC offset bias value, V_{DC}, to the tip-sample bias signal, V_{b}. This DC bias corresponds to the CPD.

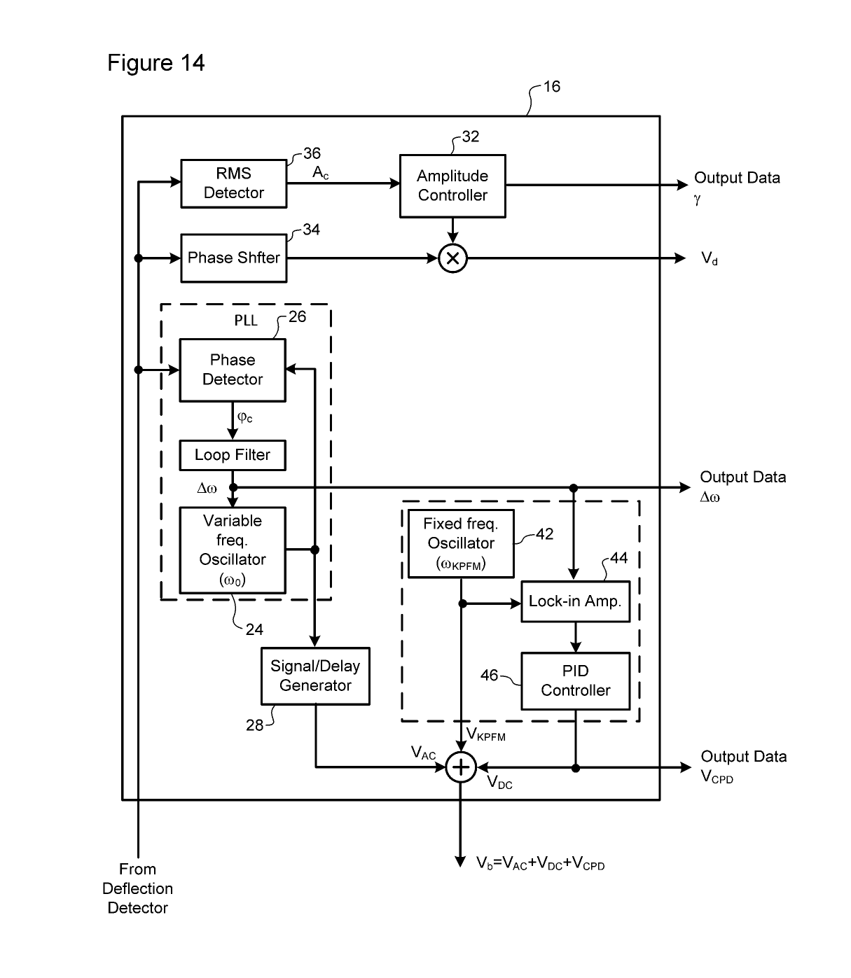

FIG. 14 is a block diagram of a dynamic mode AFM electronic module 16 with a self excitation scheme similar to that shown in FIG. 10, but with an additional FM-KPFM loop similar to that shown in FIG. 13 to set the DC applied bias.

Several variations on the instrument configurations developed herein are possible: for example, an embodiment can include an AM or FM KPFM loop for CPD compensation and a self excited, constant oscillator driven, or variable frequency oscillator driven cantilever drive signal or AC applied tip-sample bias.

Alternative embodiments could include: A torsional cantilever oscillation mode for lateral measurements with a sample electrode on or near the surface plane. A square wave applied tip-sample bias could be used instead of a sinusoid, for maximum changes in the electrostatic cantilever excitation (though this may also excite higher harmonics, depending on the transfer function). A modified KPFM technique could be implemented to set the applied bias with respect to the CPD (to measure, for example, in Regimes A, B or D instead of the general case of Regime C, as defined in FIG. 3). Multiple resonant frequencies could be used, and single pass techniques could be implemented.

The embodiments of the invention described above are intended to be illustrative only. The scope of the invention is therefore intended to be limited solely by the scope of the appended claims.

We claim:

1. A method of Atomic Force Microscopy (AFM), the method comprising:
generating a first drive signal for causing a periodic motion of a probe relative to a sample surface, the first drive signal having a known amplitude and frequency;
generating a bias signal for applying an electric potential to the probe relative to the sample, at least one component of the bias signal being oscillatory and correlated with the periodic motion of the probe;
detecting a response of the probe; and
a processor analysing the detected response to infer information about a property of the sample surface.

2. The method as claimed in claim 1, wherein the first drive signal causes a sinusoidal periodic motion of the probe.

3. The method as claimed in claim 1, wherein the bias signal is sinusoidal.

4. The method as claimed in claim 1, wherein the bias signal is a square-wave signal.

5. The method as claimed in claim 1, wherein the bias signal comprises a DC component.

6. The method as claimed in claim 5, wherein a magnitude of the DC component is proportional to a local contact potential difference (CPD).

7. The method as claimed in claim 1, wherein the at least one component of the bias signal comprises an amplitude of the bias signal.

8. The method as claimed in claim 1, wherein the at least one component of the bias signal comprises a frequency of the bias signal.

9. The method as claimed in claim 1, wherein the at least one component of the bias signal comprises a phase of the bias signal.

10. The method as claimed in claim 1, wherein detecting a response of the probe comprises detecting an open loop amplitude of the periodic motion of the probe.

11. The method as claimed in claim 1, wherein detecting a response of the probe comprises detecting an open loop phase of the periodic motion of the probe.

12. The method as claimed in claim 1, wherein detecting a response of the probe comprises detecting a closed loop frequency shift of the periodic motion of the probe.

13. The method as claimed in claim 1, wherein detecting a response of the probe comprises detecting a closed loop dissipation response of the probe.

14. The method as claimed in claim 1, wherein analysing the detected response to infer information about a property of the sample surface comprises:
calculating at least a magnitude and a sign of a slope of a tip-sample capacitance, based on the detected response;
determining a type of charge carrier within the sample based on the slope of the tip-sample capacitance; and
determining a concentration of the charge carrier within the sample, based on the magnitude of the tip-sample capacitance;

15. The method as claimed in claim 14, wherein a phase difference between the oscillating component of the bias signal and the periodic motion of the probe is an odd multiple of π/2, and wherein detecting a response of the probe comprises detecting an amplitude response of the probe.

16. The method as claimed in claim 14, wherein a phase difference between the oscillating component of the bias signal and the periodic motion of the probe is an even multiple of 90-degrees, and wherein detecting a response of the probe comprises detecting a phase response of the probe.

17. A non-transitory machine readable storage medium comprising software instructions for controlling an Atomic Force Microscopy (AFM) machine to implement the method of claim 1.
